(19) United States
(12) Patent Application Publication
(10) Pub. No.: US 2013/0008168 A1
(43) Pub. Date: Jan. 10, 2013

(54) BURNER FOR STABILIZING THE COMBUSTION OF A GAS TURBINE

(76) Inventor: Matthias Hase, Muelheim (DE)

(21) Appl. No.: 13/637,046

(22) PCT Filed: Feb. 25, 2011
(86) PCT No.: PCT/EP11/52787

§ 371 Date: Sep. 25, 2012

(30) Foreign Application Priority Data
Mar. 26, 2010 (EP) 10157921.7

(51) Int. Cl. F23R 3/34; F02C 7/224; F02C 7/08

(52) U.S. Cl. 60/733; 60/736; 60/737

(57) ABSTRACT

A burner for stabilizing the combustion of a gas turbine is provided. The burner includes a combustion chamber and a plurality of nozzles opening out into the combustion chamber wherein fluid is introduced into the combustion chamber by the nozzles in the form of a fluid jet, wherein the fluid is burned in the combustion chamber to fatal a hot gas, wherein an annular gap is provided in the case of at least one nozzle for feeding the fluid to the nozzle at a nozzle inlet, wherein a preheater is provided for heating the fluid before entering the nozzle, wherein the preheater is a pre-burner with or without a combustion chamber, and wherein the pre-burner with or without a combustion chamber is arranged in the annular gap.

### CROSS REFERENCE TO RELATED APPLICATIONS

This application is the U.S. National Stage of International Application No. PCT/EP2011/052787, filed Feb. 25, 2011 and claims the benefit thereof. The International Application claims the benefits of European Patent Office application No. 10157921.7 EP filed Mar. 26, 2010. All of the applications are incorporated by reference herein in their entirety.

### FIELD OF INVENTION

The present invention relates to a burner for stabilizing the combustion of a gas turbine which comprises a combustion chamber and a number of nozzles opening out into the combustion chamber, wherein fluid is introduced into the combustion chamber by the nozzles through a fluid jet, wherein the fluid is burned in the combustion chamber to form hot gas, wherein an annular gap is provided in the case of at least one nozzle for feeding the fluid to the nozzle at a nozzle inlet, and wherein a pre-heater is provided for heating the fluid before entering the nozzle.

### BACKGROUND OF INVENTION

Combustion systems based on pre-mixed jet flames have advantages over eddy-stabilized systems, especially from a thermoacoustic standpoint because of the distributed heat release zones and the lack of eddy-induced vortices. Suitable choice of the jet pulses allows small-scale flow structures to be generated which dissipate acoustically-induced heat release fluctuations and thereby suppress pressure pulsations which are typical of eddy-stabilized flames.

Stabilizing the combustion while at the same time achieving a very high efficiency and very low production of pollutants can be achieved here by a very strong dilution of the operating gas with combustion gases. Instead of visible flame front, a non-illuminating combustion takes place, which is also known as mild combustion, colorless combustion or volume combustion. A high volume flow of exhaust gas in the combustion zone can be achieved here by a recirculation of combustion exhaust gases, which preferably occurs within the combustion chamber. The recirculated combustion gases dilute the fresh gas introduced into the combustion chamber and also effect a high level of preheating of the gas mixture produced to temperatures above a self-ignition temperature of the operating gas. Instead of a conventional flame front, a large-volume flame zone is achieved in the volume of which a roughly even combustion takes place.

However a stabilization of the combustion is necessary precisely in the part load range or basic load range with pressure pulsations in the mid- or high-frequency range.

### SUMMARY OF INVENTION

The object of the invention is thus to specify a burner that produces a stable combustion with low pressure pulsations precisely in the part load range or in the basic load range of the burner at which pressure pulsations predominate in the mid- or high-frequency range.

The object is achieved by a burner for stabilizing the combustion of a gas turbine in accordance with the claims. The dependent claims contain further advantageous embodiments of the invention.

In this case the inventive burner for stabilizing the combustion of a gas turbine comprises a combustion chamber and a number of nozzles opening out into the combustion chamber, especially jet nozzles. Fluid is introduced with the jet nozzles through a fluid jet into the combustion chamber. In this process the fluid is burned in the combustion chamber to form hot gas. With the least one fluid jet an annular gap is also provided via which the fluid is fed to the fluid jet at a nozzle inlet, especially a fluid jet inlet.

It has been recognized that precisely with jet-based combustion systems a high air pre-heating temperature is advantageous as a measure against pressure pulsations.

In such cases it is not the low load range with a leaner quench limit with low-frequency pressure pulsations that is important but the part load or basic load range with pressure pulsations in the mid- or high-frequency range which is the decisive factor. It has been recognized that the pre-heating temperatures to be aimed for occur beyond a thermodynamic gas turbine process of 25 bar. These preheating temperatures are however generally not achieved for the current gas turbine generation. However even for gas turbine processes which achieve this pressure there is still a potential available for reducing pressure pulsations by a higher burner air temperature.

In accordance with the invention there is now provision for a pre-heater, wherein the pre-heater is a pre-burner with or without combustion chamber or a heat exchanger. In such cases the pre-burner with or without combustion chamber or the heat exchanger is disposed in the annular gap. Thus the fluid is heated especially efficiently before it enters the nozzle, especially the jet nozzle. This measure, which is easy to implement in manufacturing terms, solves the problem of the fluid temperature, especially of the air temperature or the air/fuel temperature before entry into the jet nozzle, which also means into the combustion chamber. By the use of such a pre-heater and the associated fluid preheating an improvement in the stability of the combustion of a burner, especially a jet burner, is achieved.

The fluid temperature is now increased by the inventive burner before entry into the burner. The stability of the burner is significantly increased by this.

### BRIEF DESCRIPTION OF THE DRAWINGS

Further features, characteristics and advantages of the present invention are described below on the basis of exemplary embodiments which refer to the enclosed figures, in which:

FIG. 1 shows a schematic section from a gas turbine with a combustion chamber in a longitudinal section along a shaft axis in accordance with the prior art,

FIG. 2 shows a schematic section through a combustion chamber transverse to its longitudinal direction with a jet burner,

FIG. 3 shows a schematic section through a further jet burner transverse to this longitudinal direction,

FIG. 4 shows a schematic cross section of a burner,

FIG. 5 shows a first example of an inventive burner with pre-burner,

FIG. 6 shows a pre-heater embodied as a heat exchanger which is arranged in the annular gap,

FIG. 7 shows an inventive heat exchanger annular gap,

### DETAILED DESCRIPTION OF INVENTION

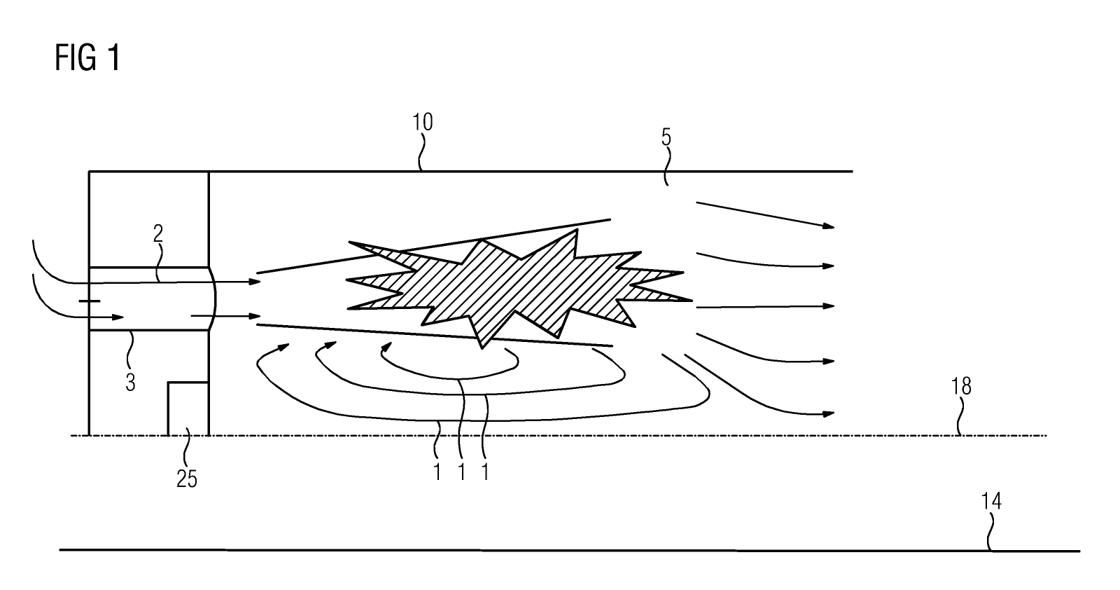

FIG. 1 shows a section from a gas turbine with a shaft not shown in the figure disposed along a shaft axis 14 and a combustion chamber 5 aligned in parallel to the shaft axis 14 in a longitudinal section. The combustion chamber 5 is arranged rotationally symmetrically around a combustion chamber axis 18. The combustion chamber axis 18 is disposed in this specific exemplary embodiment in parallel to the shaft axis 14, wherein it can also run at an angle to the shaft axis 14, in an extreme case at right angles to the latter. An annular housing 10 surrounds the combustion chamber 5. By means of a prior art nozzle jet 3 a fluid, mostly air or air/fuel mixture, is introduced into the combustion chamber 5. The recirculating hot gases 4 in the combustion chamber 5 are indicated by the number 1.

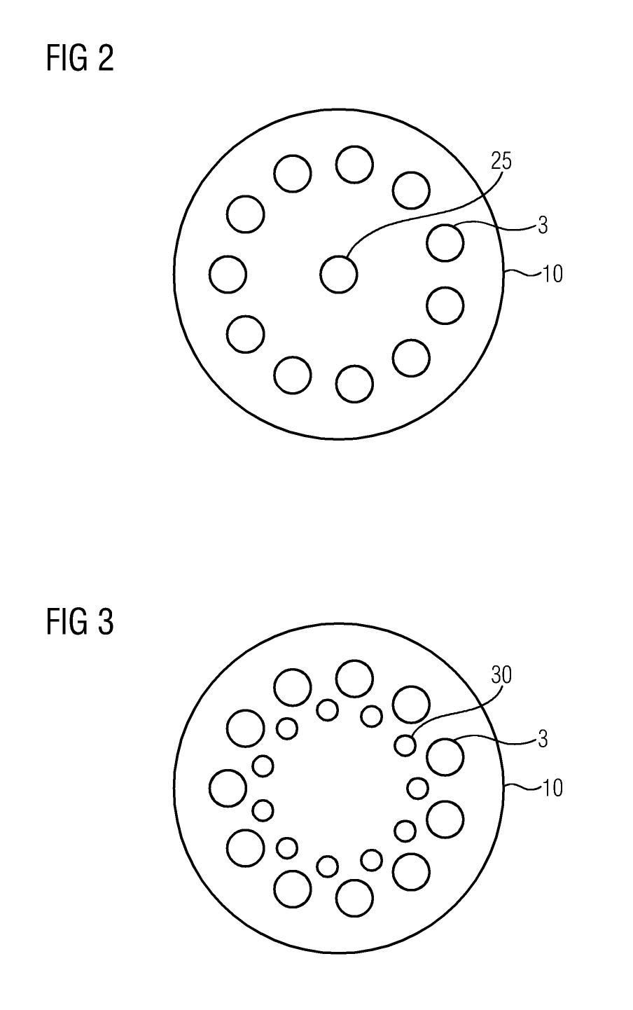

FIG. 2 shows a schematic section through a jet burner at right angles to a shaft axis 14 (FIG. 1) of the burner. The burner comprises a housing 10 which has a circular cross section. Disposed within the housing 10, essentially in the form of a ring, are a specific number of jet nozzles 3. Each jet nozzle 3 in this case has a circular cross section. In addition the burner can include a pilot burner 25.

FIG. 3 shows a schematic section through a further jet burner, with the section running at right angles to the central axis of the further burner. The burner likewise has a housing 10 which possesses a circular cross section and in which a number of inner and outer jet nozzles 3, 30 are disposed. The jet nozzles 3, 30 each have a circular cross section, wherein the outer jet nozzles 3 possess a cross-sectional surface which is the same size or larger than the inner jet nozzles 30. The outer jet nozzles 3 are essentially disposed in the form of a ring within the housing 10 and form an outer ring. The inner jet nozzles 30 are likewise disposed within the housing 10 in the form of a ring. The inner jet nozzles 30 form an inner ring which is disposed concentrically to the outer jet nozzle ring.

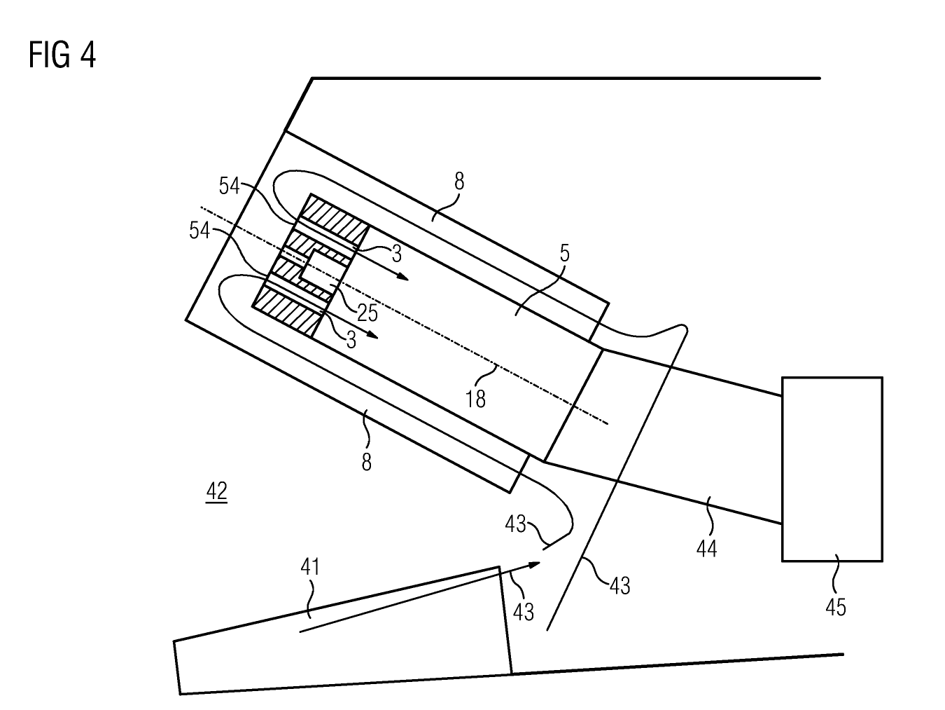

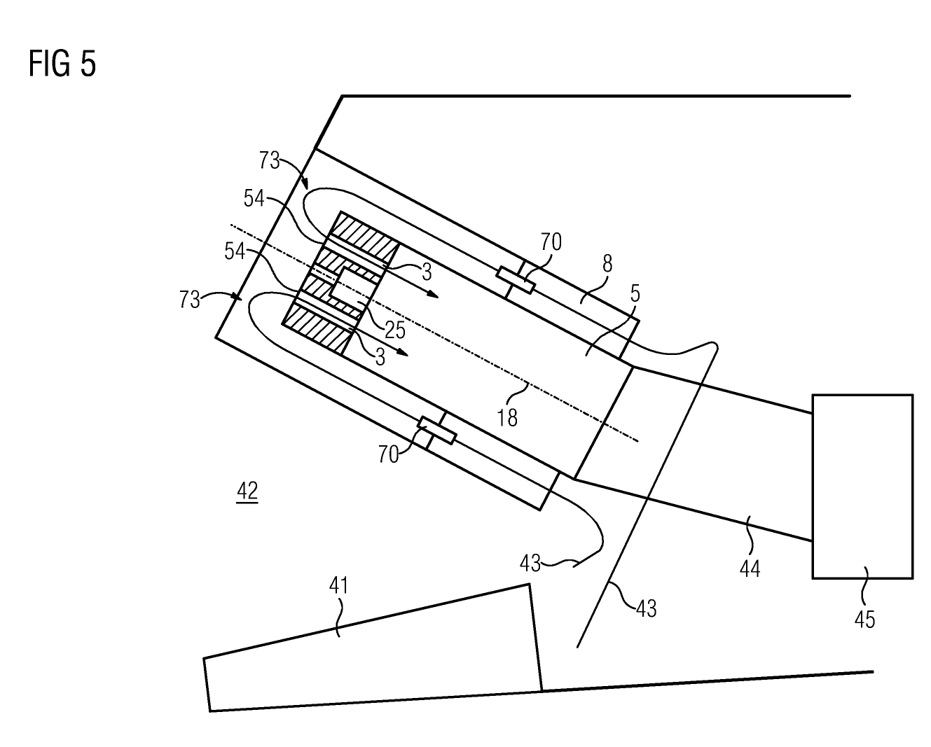

FIG. 4 shows the schematic cross section of a burner. This features a compressor with compressor outlet diffuser 41. The burner also features an annular gap 8 which is located partly on the outside the combustion chamber at the nozzle and partly on the outside of the combustion chamber at the combustion chamber 5. The annular gap 8 is used here for outer flow guidance of the compressed air 43 or the air/fuel mixture, which is compressed by the compressor and exits at the compressor outlet diffuser 41 and is mixed with fuel subsequently or during the process. In this case this compressed air 43 or the mixture flows against the direction of flow of the hot gases which obtains in the combustion chamber 5 and which is referred to as the combustion chamber flow direction. The air 43 or the air/fuel mixture flows in the annular gap 8 to the inlet of the jet nozzle 3, the jet nozzle inlet 54 and then flows through the nozzle 3 to the combustion chamber 5, where for example it is burned with the aid of the pilot burner 25. The static pressure difference can be used for this (high flow speed in gap 8). A plenum 42 is provided between compressor outlet diffuser 41 and annular gap 8. Located downstream from the combustion chamber in the combustion chamber flow direction is a transition section 44, which adjoins a turbine 45.

FIG. 5 shows a first example of an inventive burner with pre-burner 70. This is disposed in annular gap 8. The compressed air 43 flows out of the diffuser outlet 41 through the plenum 42. Subsequently the compressed air 43 (or the air/fuel mixture) flows into the annular gap 8 and flows there against the combustion chamber flow to the inlet of the jet nozzle 3, the jet nozzle inlet 54. The air 43 is mixed in the annular gap 8 with injected fuel and is burned by the pre-burner 70 in the annular gap 8.

Thus the air temperature (air/fuel temperature) is increased before entry into the jet nozzle 3 so that a significant improvement in the stability of the combustion occurs precisely in the part load or basic load area with pressure pulsations in the mid- or high-frequency range.

The at least one jet nozzle and also optionally a pilot burner is referred to as the main stage or main burner.

For an even temperature increase of the air the most even possible distribution of the exhaust gas generated is advantageous. The result of this is that a longest possible mixing path to the jet burner functioning as the main burner is advantageous.

The pre-burner 70 can be embodied with a Rich-Quench-Lean (RQL) combustion concept, as a single or ring burner with or without combustion chamber. The RQL combustion concept means that directly downstream of a burner via which a fuel-rich, rich air/fuel mixture is introduced into the combustion chamber, this fuel-rich mixture (=rich burn) is initially partly burned, wherein the still burning combustion gases are subsequently rapidly cooled down (quick quench) and subsequent burning is fuel-lean (=lean burn). As a result of the initial rich burning, lower temperatures can be produced in the combustion chamber 5, so that NOx formation is reduced.

If an RQL combustion concept is involved here the pre-burner 70 is preferably operated rich and the main stage is operated lean. The quench is supplied by the annular gap flow. The pre-burner 70 can in this case be attached variably in the annular gap 8 over the entire axial length L in relation to the combustion chamber axis 18.

The annular gap 8 has a redirection area 73. The redirection area 73 is used to transport the air 43 or the air/fuel mixture to the nozzle inlet 54. This redirection area 73 can amount to about 180°.

The pre-burner 70 can for example also be disposed in the redirection area 73. It is also possible for the pre-burner to be disposed directly in front of the nozzles 3 of the main combustion stage. In this embodiment it is advantageous to dispose the pre-burner(s) 70 in series with the nozzles 3 so that an exact distribution of the pre-heated air is guaranteed.

The pre-burner 70 can be attached as (several) single or ring burners, as a lean premix burner, has a rich-quench-lean concept or at different positions on the entire axial length L related to the combustion chamber axis 18 in the annular gap 8.

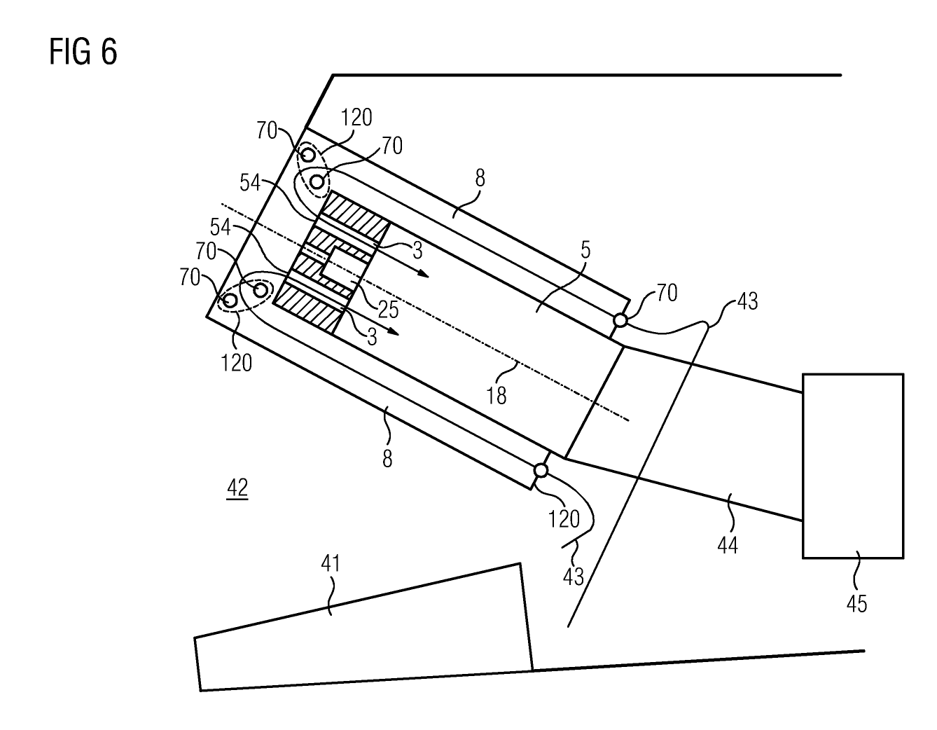

In FIG. 6 the pre-heater is embodied as a heat exchanger 120. The heat exchanger 120 is provided in the annular gap 8.

The heat exchanger 120 is operated in this case by the exhaust gas of the gas turbine. In this case the heat exchanger 120 can consist of a number of tubes 71 (tubular heat exchanger 120), which are used for explicit distribution of the air. In such cases, depending on the tube diameter, more than one tubular heat exchanger 120 can be placed in the annular gap 8. In this case the tubes 71 have air 43 compressed with a compressor flowing onto them at high speed which produces an effective heat transfer. If the temperature increase is not needed at basic load or almost basic load, a control element (not shown) fitted externally can be used to stop the supply of exhaust gas and the exhaust gases can for example be routed entirely to a downstream steam generator (the principle is also the same for the pre-heater). It is thus also possible to embody the heat exchanger 120 to be movable in order to avoid the flow pressure losses occurring during basic load or after the basic load. A more effective heat transfer between exhaust gas and compressed air 43 is possible precisely at part load, since the gas turbine is driven at almost constant exhaust gas temperature, while the end temperature of the compressed air 43 only rises with an increasing load.

It is possible in this case to dispose the heat exchanger 120 at different positions, e.g. especially different axial positions, between the entry into the annular gap 8 and the jet nozzle inlet 54, which is mostly embodied as a 180° redirection area. This is especially advantageous since the heat exchanger 120 can then be used for evening out the flow. The imminent pressure loss is used positively in this way. An improved, more stable operating behavior is brought about by the evening out of the flow which is characterized by improved CO and NOx values. There is also the possibility, as with all pre-heaters, of switching off the pre-heater embodied as a heat exchanger 120 or also of moving the pre-heater, if the combustion chamber 5 is suitably designed or constructed, out of the flow path. Through the action of the heat exchanger 120 as a flow equalizing device, other measures for flow equalization can be largely dispensed with. The pressure loss of these measures would then compensate for an eventual pressure loss by the pre-heater 120 so that this would not create any pressure loss or only a very small pressure loss.

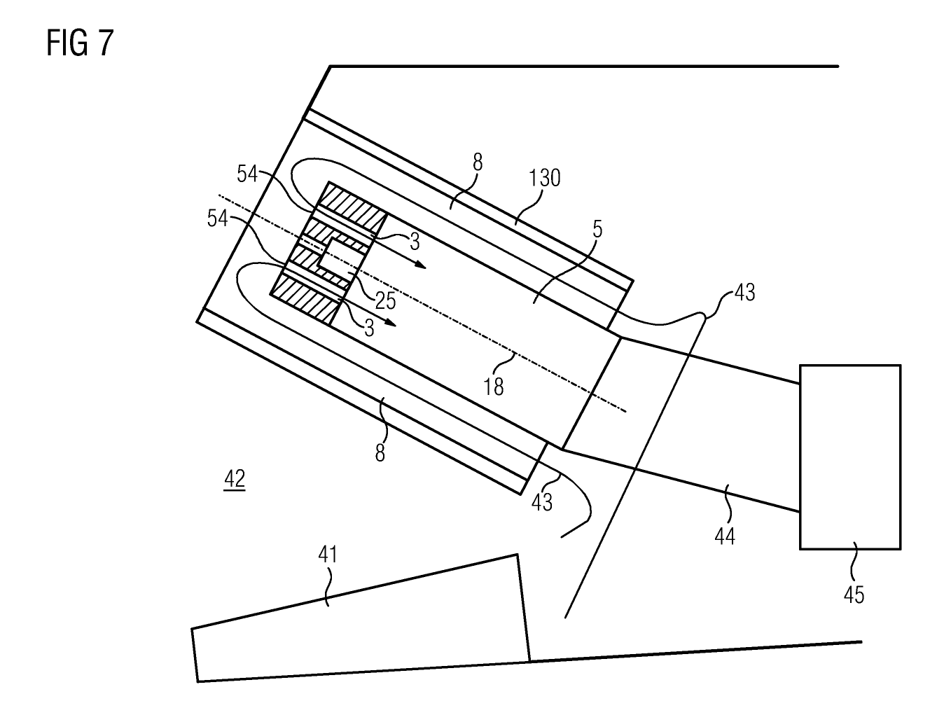

FIG. 7 shows a pre-heater embodied as a heat exchanger 130 which is embodied as a heat exchanger annular gap 130. The heat exchanger annular gap 130 can in this case have channels passing though it in the shape of a spiral, which form a contraflow heat exchanger (not shown). In such cases a number of independent channels can also be present, which for example are routed back externally to the heat exchanger annular gap 130 (not shown). The heat exchanger annular gap 130 thus embodied has the advantage that no additional flow resistance forms.

The capacity of all pre-heaters shown is embodied as a function of the desired temperature increase and the operating mode (rich/lean combustion).

All pre-heaters in such cases are embodied such that the generated exhaust gases do not strike a wall of the previous burner system and cause thermal damage there.

For even mixing a longest possible mixing path between the hot gas produced by the pre-heaters and the air 43 (or the air/fuel mixture) is aimed for.

In addition eddy or turbulence-generating elements can be employed to improve the mixing.

In addition it is possible, in the annular gap 8 around the combustion chamber 5, to mix in exhaust gases from the gas turbine in order to increase the temperature of the fresh gas. An external compressor (not shown) is necessary for this purpose to bring the exhaust gases to the required pressure. This adding-in can for example also be switched off at basic load or close to basic load if required.

In addition possible exhaust gases from the steam generator can also be introduced before a first compressor series or in a first compressor series. This also increases the air temperature at the compressor outlet diffuser 41. Here too an external compressor is needed.

The enriching of the oxygen in the air offers advantages in NOx generation because of kinetic effects.

Any negative effect of the pre-heater on NOx arising can be compensated for at least partly by a reduction in the pilot gas.

1-10. (canceled)

11. A burner for stabilizing the combustion of a gas turbine, comprising:
a combustion chamber;
a plurality of nozzles opening out into the combustion chamber;
an annular gap; and
a pre-heater,
wherein fluid is introduced into the combustion chamber with the plurality of nozzles through a fluid jet,
wherein the fluid is burned in the combustion chamber to form hot gas,
wherein the annular gap is provided in the case of at least one nozzle via which the fluid is fed to the nozzle at a nozzle inlet and whereby the pre-heater is provided, which heats the fluid before its entry into the nozzle,
wherein the pre-heater is a pre-burner with or without combustion chamber, and
wherein the pre-heater with or without combustion chamber is arranged in the annular gap.

12. The burner as claimed in claim 13,
wherein a jet nozzle is provided as the nozzle and a jet nozzle inlet is provided as the nozzle inlet.

13. The burner as claimed in claim 13,
wherein the annular gap is provided at least over the entire axial length of the nozzle and at least part of the combustion chamber.

14. The burner as claimed in claim 13,
wherein the annular gap is provided at least at the nozzle inlet.

15. The burner as claimed in claim 13,
wherein the pre-burner is embodied as a ring burner.

16. The burner as claimed in claims 13,
wherein the pre-burner is embodied as a ring segment burner with or without interruption.

17. The burner as claimed in claim 13,
wherein the pre-burner is embodied as a single burner.

18. The burner as claimed in claim 13,
wherein the annular gap includes a redirection area which diverts the fluid into the nozzle inlet, and
wherein the pre-burner with or without combustion chamber is arranged in the redirection area.

19. The burner as claimed in claim 13, wherein a main stage is provided, which includes the at least one nozzle as well as a pilot burner.

20. The burner as claimed in claim 13, wherein a rich-quench-lean combustion concept is able to be executed with the pre-burner.
